(19) United States
(12) Patent Application Publication
(10) Pub. No.: US 2011/0277716 A1
(43) Pub. Date: Nov. 17, 2011

(54) Intake Manifold for an Internal Combustion Engine

(75) Inventors: Wayne Groleau, Beverly Hills, MI (US); Christopher K. Clarke, Commerce Twp., MI (US)

(73) Assignee: GM GLOBAL TECHNOLOGY OPERATIONS, INC., Detroit, MI (US)

(21) Appl. No.: 12/909,017

(22) Filed: Oct. 21, 2010

Related U.S. Application Data
(60) Provisional application No. 61/345,354, filed on May 17, 2010.

(51) Int. Cl. F02M 35/10

(52) U.S. Cl. 123/184.24

(57) ABSTRACT

An internal combustion engine comprises a cylinder block, a cylinder head mounted on the cylinder block, and an intake manifold assembly. The intake manifold assembly comprises an inboard disposed inboard disposed zip tube, an outboard disposed intake manifold plenum fluidly connected to and configured to receive combustion air from the zip tube and a plurality of intake runners fluidly connected to and configured to transport combustion air from the intake manifold plenum to the cylinder head.

### CROSS-REFERENCES TO RELATED APPLICATIONS

This application claims priority to U.S. Provisional Application Ser. No. 61/345,354 filed May 17, 2010 which is hereby incorporated herein by reference in its entirety.

### FIELD OF THE INVENTION

Exemplary embodiments of the present invention relate to intake systems for internal combustion engines and, more particularly, to a compact and fluidly efficient intake manifold assembly having an inboard configured zip tube and associated throttle body assembly.

### BACKGROUND

With the increased focus on vehicle economy, particularly vehicle fuel economy, automotive manufacturers are turning to smaller, lighter vehicles and alternative vehicle powertrains such as hybrid powertrains to boost efficiency. In a typical hybrid powertrain, motive force is generated through a combination of a small internal combustion engine (diesel or gasoline) and an electric motor or motors.

In certain operating modes the internal combustion engine is turned off (ex. stop and go city traffic) and the vehicle may be propelled by the electric motor drawing power from a battery pack. In such operating modes, however, certain vehicle functions such as power steering and cabin air conditioning, which are typically powered by the internal combustion engine in a conventional powertrain configuration, must still be provided. To provide these functions, designers of some hybrid vehicles have replaced traditional, engine powered units with electrical units (i.e. electric power steering and air conditioning). These units may be larger than the traditional units they replace and, as such, may provide challenges to vehicle designers who are presented with increasingly smaller vehicles in which to package the powertrain components; especially in the under hood environment. Such challenges have required a re-thinking of the design of other traditional engine components.

### SUMMARY

In an exemplary embodiment an internal combustion engine comprises a cylinder block, a cylinder head mounted on the cylinder block, and an intake manifold assembly. The intake manifold assembly comprises an inboard disposed zip tube, an outboard disposed intake manifold plenum fluidly connected to and configured to receive combustion air from the zip tube and a plurality of intake runners fluidly connected to and configured to transport combustion air from the intake manifold plenum to the cylinder head.

The above features and advantages, and other features and advantages of the present invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a front view of an internal combustion engine embodying features of the invention;

FIG. 2 is a rear view of an intake manifold assembly of the internal combustion engine of FIG. 1;

FIG. 3 is a top view of the intake manifold assembly of FIG. 2; and

FIG. 4 is a perspective view of an air induction system for the internal combustion engine of FIG. 1.

### DESCRIPTION OF THE EMBODIMENTS

The following description is merely exemplary in nature and is not intended to limit the present disclosure, application or uses. It should be understood that throughout the drawings, corresponding reference numerals indicate like or corresponding parts and features.

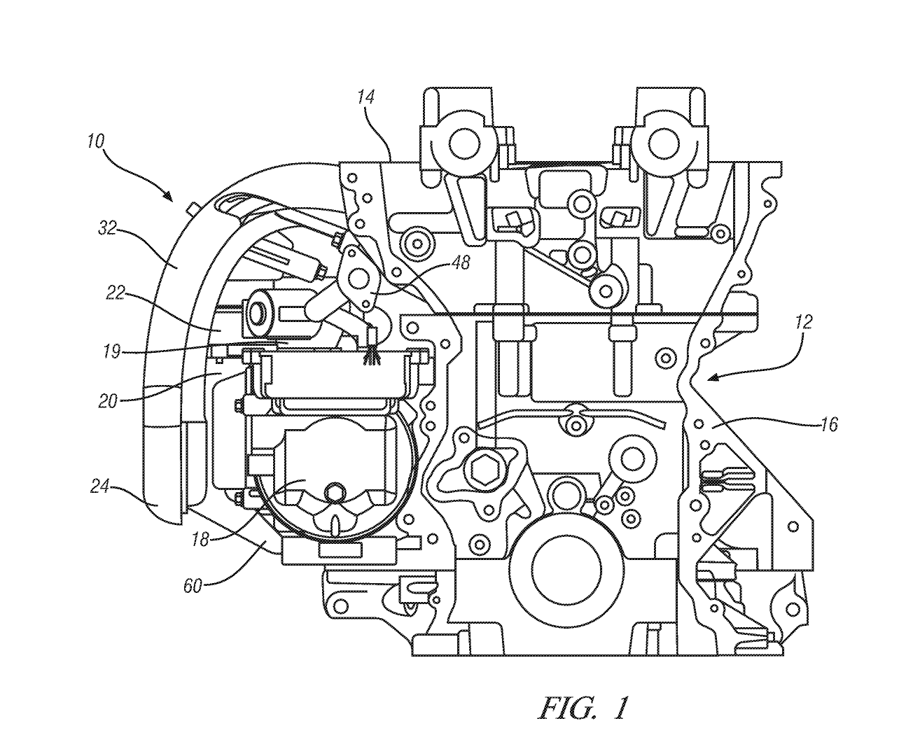

Referring now to FIG. 1, an exemplary embodiment of the invention is directed to an intake manifold assembly 10 that is configured to deliver combustion air to a cylinder head 14 of an internal combustion engine 12. The cylinder head 14 is mounted to a cylinder block 16. In an exemplary embodiment, the internal combustion engine in the embodiment illustrated in FIG. 1, is part of a hybrid vehicle powertrain. The internal combustion engine 12 may include an electric air conditioning unit 18 mounted thereon which operates on electrical/battery power to condition the vehicle cabin air for the comfort of the vehicle occupant(s) whether or not the internal combustion engine is operating.

In an exemplary embodiment illustrated in FIGS. 1-4, an intake manifold assembly 10 includes a zip tube 20 that performs several functions including acting as a support for throttle body 22. The throttle body 22 meters the quantity of combustion air delivered to the cylinder head 14 through the inlet opening 19 of the zip tube 20. The zip tube 20 is located inboard of, and is fluidly connected to an intake manifold plenum 24 which is configured to receive the combustion air passing though the throttle body 22, and to distribute the combustion air to a plurality of intake runners 26, 28, 30 and 32. Each of the intake runners 26, 28, 30 and 32 delivers combustion air to an individual combustion chamber (not shown) in the cylinder head 14. The inboard location of the zip tube 20 and the throttle body 22 (i.e. between the manifold plenum 24 and the cylinder block 16 allows for efficient packaging of the entire intake manifold assembly 10 with respect to the internal combustion engine 12 and in the vehicle (not shown).

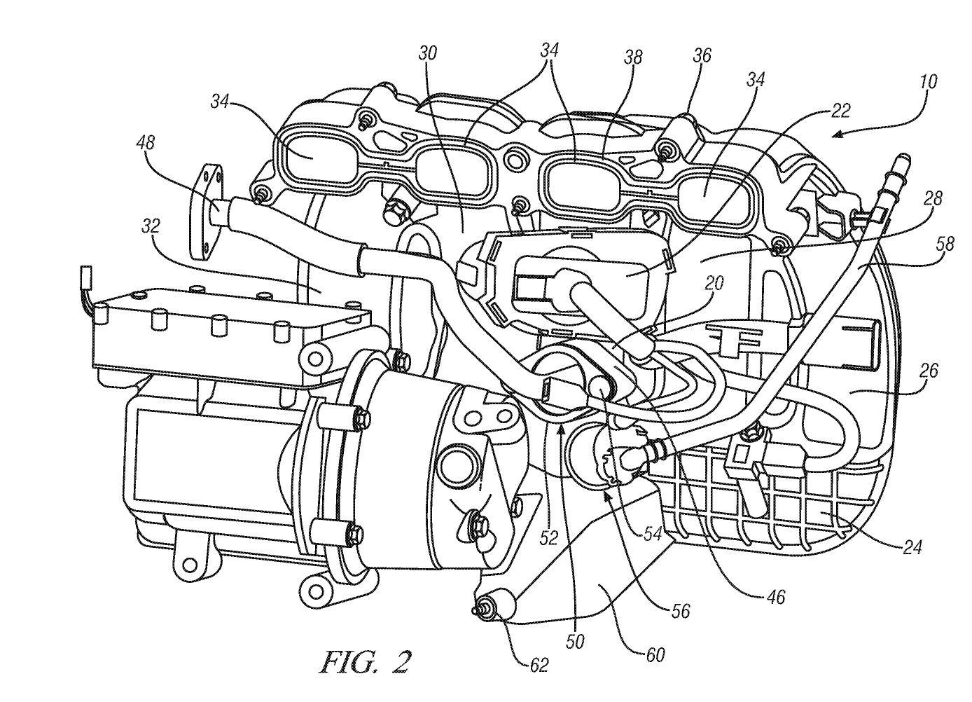

As illustrated in FIG. 1, the placement of the zip tube 20 and the throttle body 22 inboard of the intake manifold plenum 24, between the plenum and the cylinder block 16 also allows for a fluidly efficient configuration of the intake runners 26, 28, 30 and 32. The intake runners extend upwardly from the intake manifold plenum 24 and engage in a smooth curve (about 90 degrees) to terminate at outlet ports 34, FIG. 2, which are fluidly and sealingly connected to inlet ports (not shown) of the cylinder head 14. The intake manifold assembly 10 is connected to the cylinder head 14 through the use of suitable fasteners such as bolts 36, FIGS. 2, 3 and 4. Compressible sealing members (not shown) are typically disposed in seal grooves 38, FIG. 2, to assure a leak free connection between the intake manifold and the inlet ports of the cylinder head 14.

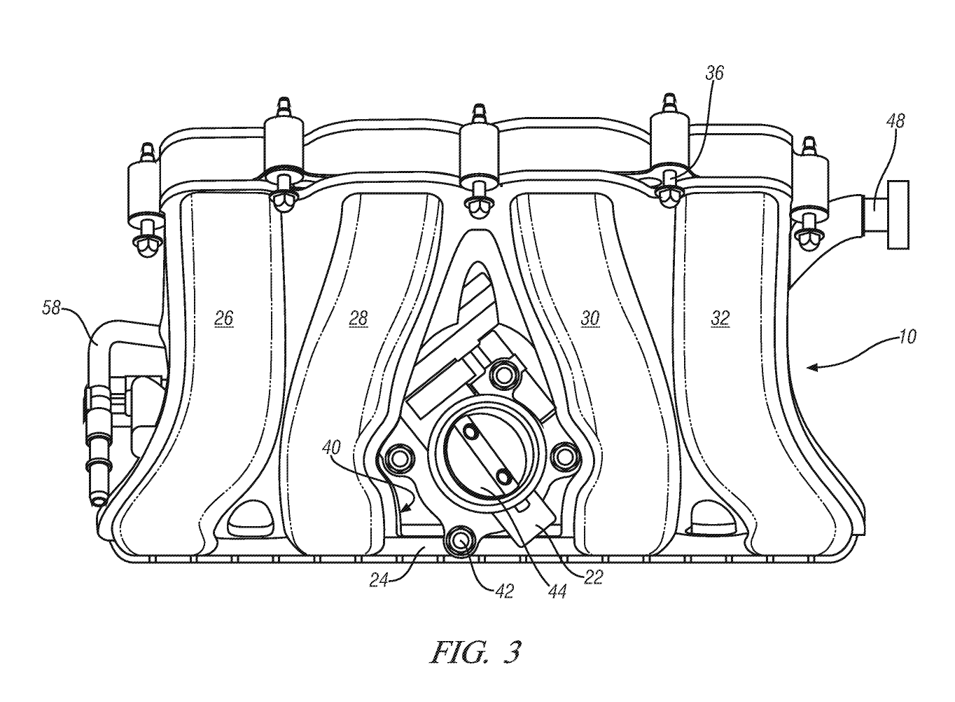

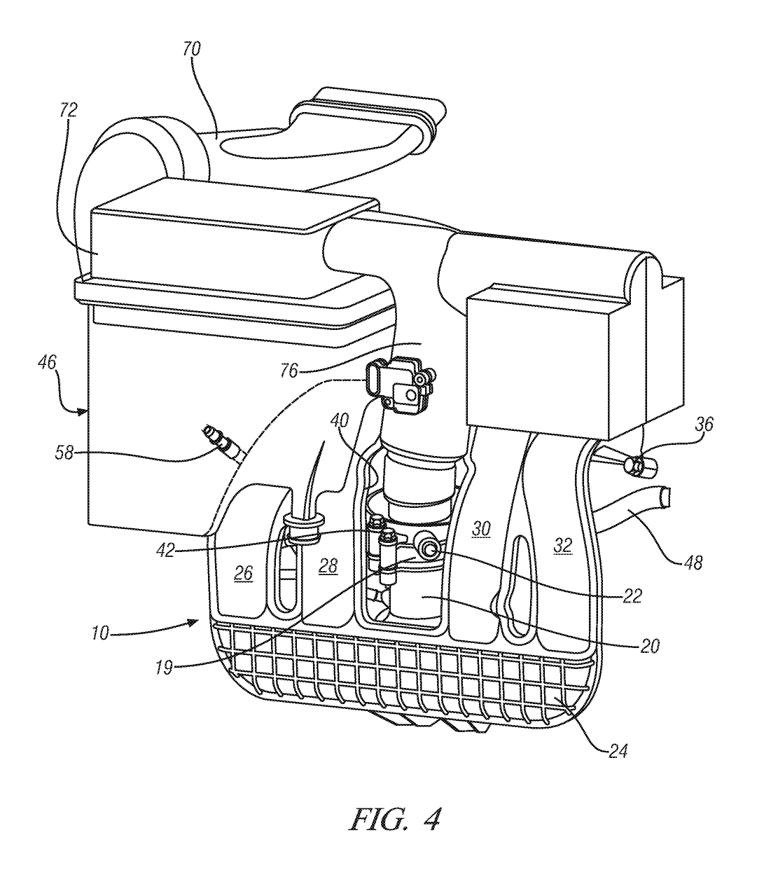

Referring now particularly to FIGS. 3 and 4, in an exemplary embodiment, the intake runners 28, 30 are axially skewed, in opposing directions, along the axial length of the intake manifold plenum 24 to thereby define an access opening 40 to the throttle body 22 and zip tube 20. The throttle body 22 is mounted to the zip tube 20, and consequently to the intake manifold assembly 10, utilizing a series of fasteners such as bolts 42. In its mounted configuration, the inlet opening 44 of the throttle body 22 is positioned such that it faces upwardly though the access opening 40 of the intake manifold assembly 10. In this configuration, fluid communication with an upstream air induction system 46, FIG. 4, is easily facilitated. Such ease of access to the throttle body opening 44 of the throttle body 22 provides for simplified assembly of air induction system 46 to the intake manifold assembly 10 during manufacture of the vehicle powertrain. The air induction system may include an inlet conduit 70 an air box 72 including an air filter (not shown) and a throttle body conduit 76 that is configured to deliver filtered combustion air to the throttle body 22.

Referring now to FIGS. 1 and 2, in an exemplary embodiment, the zip tube 20, located between the intake manifold plenum 24 and the throttle body 22 may include an inlet 46 that is in fluid communication with an exhaust gas recirculation (“EGR”) conduit 48 for delivery of recirculated exhaust gas to the combustion air passing therethrough. The inlet 46 is surrounded by a flanged surface 50 that is configured to receive a mating flange 52 for sealing engagement with the conduit 48. Suitable fasteners such as bolts 54 are utilized to connect the EGR conduit 48 to the zip tube 20. In addition, in an exemplary embodiment, a purge gas valve 56 may also be located in fluid communication with the zip tube 20 and is configured to fluidly connect the purge gas conduit 58 with the combustion air flow therethrough. In addition, a mass airflow sensor (not shown) may be positioned between the throttle body 22 and the zip tube 20 and is configured to measure the flow of combustion air that passes through the throttle body 22 to the intake manifold plenum 24.

In an exemplary embodiment shown in FIGS. 1 and 2, a mounting spacer 60 extends inboard from the intake manifold assembly 10 and is useful to both mount, through the use of attachment feature 62 and to position the intake manifold assembly 10 with respect to the internal combustion engine 12. The mounting spacer 60 allows for precise positioning of the intake manifold assembly 10 relative to the internal combustion engine 12 as well as reducing or eliminating vibration between the two assemblies which could result in leakage at the interfaces thereof.

While the present invention has been described with reference to its application to a hybrid configured powertrain, it should be apparent, and is contemplated that such an intake manifold assembly has similar applications to standard, non-hybrid powertrain applications in which space and efficiency is desirable.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. An internal combustion engine comprising:
a cylinder block;
a cylinder head mounted on the cylinder block;
an intake manifold assembly comprising;
an inboard disposed zip tube;
an outboard disposed intake manifold plenum fluidly connected to and configured to receive combustion air from the inboard disposed zip tube; and
a plurality of intake runners fluidly connected to and configured to transport combustion air from the intake manifold plenum to the cylinder head.

2. The internal combustion engine of claim 1, wherein the plurality of intake runners are axially skewed, in opposing directions, along an axial length of the intake manifold plenum to define an access opening to the zip inboard disposed zip tube.

3. The internal combustion engine of claim 2, wherein the inboard disposed zip tube includes an opening that is configured to receive the combustion air through a throttle body mounted, through the access opening, thereon.

4. The internal combustion engine of claim 3, wherein the throttle body includes an inlet opening positioned such that it faces upwardly though the access opening of the intake manifold assembly for fluid communication with a throttle body conduit of an upstream air induction system.

5. The internal combustion engine of claim 1, wherein the inboard disposed zip tube further comprises an exhaust gas inlet that is in fluid communication with an exhaust gas recirculation conduit for delivery of recirculated exhaust gas to the combustion air passing therethrough.

6. The internal combustion engine of claim 1, further comprising a purge gas valve disposed in fluid communication with the inboard disposed zip tube and configured to fluidly connect a purge gas conduit to the inboard disposed zip tube for delivery of purge gas to the combustion air passing therethrough.

7. The internal combustion engine of claim 1, further comprising a mounting spacer that extends inboard from the intake manifold plenum to mount to, through the use of an attachment feature, and to position the intake manifold assembly with respect to the internal combustion engine.

8. The internal combustion engine of claim 1, wherein the plurality of runners extend upwardly from the intake manifold plenum and engage in a smooth curve of about 90 degrees to terminate at outlet ports that fluidly and sealingly connect to inlet ports of the cylinder head.

9. An intake manifold assembly for an internal combustion engine having a cylinder head, the intake manifold assembly comprising:
an inboard disposed zip tube;
an outboard disposed intake manifold plenum fluidly connected to and configured to receive combustion air from the inboard disposed zip tube; and
a plurality of intake runners fluidly connected to and configured to transport combustion air from the intake manifold plenum to the cylinder head.

10. The intake manifold assembly of claim 9, wherein the plurality of intake runners are axially skewed, in opposing directions, along an axial length of the intake manifold plenum to thereby define an access opening to the inboard disposed zip tube.

11. The intake manifold assembly of claim 10, wherein the inboard disposed zip tube includes an opening that is configured to receive the combustion air through a throttle body mounted, through the access opening, thereon.

12. The intake manifold assembly of claim 11, wherein the throttle body includes an inlet opening positioned such that it faces upwardly though the access opening of the intake manifold assembly for fluid communication with a throttle body conduit of an upstream air induction system.

13. The intake manifold assembly of claim 9, wherein the inboard disposed zip tube further comprises an exhaust gas inlet that is in fluid communication with an exhaust gas recirculation conduit for delivery of recirculated exhaust gas to the combustion air passing therethrough.

14. The intake manifold assembly of claim 9, further comprising a purge gas valve disposed in fluid communication with the inboard disposed zip tube and configured to fluidly connect a purge gas conduit to the inboard disposed zip tube for delivery of purge gas to the combustion air passing therethrough.

15. The intake manifold assembly of claim 9, further comprising a mounting spacer extending inboard from the intake manifold plenum to mount to, through the use of an attachment feature, and to position the intake manifold assembly with respect to the internal combustion engine.

16. The intake manifold assembly of claim 9, wherein the plurality of intake runners extend upwardly from the intake manifold plenum and engage in a smooth curve of about 90 degrees to terminate at outlet ports that fluidly and sealingly connect to inlet ports of the cylinder head.
